(19) United States
(12) Patent Application Publication
(10) Pub. No.: US 2008/0043567 A1
(43) Pub. Date: Feb. 21, 2008

(54) Treatment Device for Plastic Products for the Purpose of Recycling and Process for Using Such Device

(75) Inventor: Jacques Mot, Cologny (CH)

Correspondence Address: HARNESS, DICKEY & PIERCE, P.L.C., P.O. BOX 828, BLOOMFIELD HILLS, MI, 48303, US

(73) Assignee: PLASTINUM CORP., New York, NY (US)

(21) Appl. No.: 11/587,364

(22) PCT Filed: May 6, 2005
(86) PCT No.: PCT/EP05/04926

§ 371 Date: Jun. 7, 2007

(30) Foreign Application Priority Data
May 10, 2004 (EP) 04 011 065.2

(51) Int. Cl. B29B 17/00; B01F 15/00; B01F 7/04; B29B 7/26; B29B 7/44; B29B 7/16; B01F 7/18

(52) U.S. Cl. 366/102; 366/144; 366/279; 366/290; 366/318; 366/319

(57) ABSTRACT

A device for processing plastics for recycling purposes, including adjustable oval blades (6) enabling improved mixing properties to be achieved, particularly in terms of the mixing time, and further readily adaptable for use with a variety of different mixtures. A method for processing plastics using said device is also disclosed.

This invention refers to a device enabling the treatment of plastic products for the purpose of recycling, and to a treatment process for the plastic products using such device.

### PRIOR ART

Plastic products, especially thermoplastic products, due to their amount of use, their properties and their structure, are excellent candidates for the various recycling processes. Indeed, products such as PET, PVC, PP, PS and similar, are among the products recycled the most. Several processes have been identified with the aim of recycling plastic products through the heating of plastic products via an external source of heat, allowing such products to melt for the purpose of enabling a new homogeneous or same-type product to be obtained. Having said that, the supply of external thermic heat is costly and hardly beneficial from an economic point of view.

Document WO 92/18310 describes a device and a process using such device for treating various plastic products mixed together, where the plastic products are subjected to shaking and stirring through action by the rotor equipped with fixed blades revolving at high speed in accordance with the rotor axle, thus heating the plastic products by friction until achieving a homogeneous paste composed of the various plastic products initially heterogeneous. Such device has the inconvenience of having an invariable operating system and of not being adaptable to the products treated for the purpose of enhancing the process according to the varying quality of waste.

### SUMMARY OF THE INVENTION

The aim of this invention is to propose a treatment device which, by simple operation, can be adapted to a number of plastic products' waste mixture types for the purpose of enhancing its homogeneity at mixture quality level, as well as during the treatment period.

An aim of this invention is to provide a device equipped with a rotating shaft so that the various plastic products combine, the blades of which, being of a conventional length and shape, can be shifted and orientated in a manner that will improve the mixture in accordance with the properties of the treated products.

Another aim of this invention is to propose a system for holding the blades of conventional length and shape, which may be used in the context of this invention.

Another aim of this invention is to provide an installation enabling better conservation during manipulation of the product treated by the said device.

Another aim of this invention is to provide a low-cost and easy-to-use recycling process for plastic products.

This invention enables an excellent mixing of the various products until achieving a new reusable homogeneous product. In order to attain these aims, the device includes:

a mixing chamber;

a product inlet and outlet;

a conveying screw for evacuation;

at least one rotor in the mixing chamber equipped with blades,

characterised by the fact that the said blades are fixed onto the said rotor in a rotating manner around the axles perpendicular to the rotor axle.

An advantage is that the rotating blades can be positioned in at least five different angles, or more depending on the need. The person skilled in the art will appreciate the fact that orientation clearly favours mixing and improves the diffusion of the different product flows created by the cutting of the blades.

Other aims and advantages of the invention shall be highlighted in the following detailed description. The detailed description and the specific embodiments described are only provided as examples; any additions and modifications shall be obvious for the person skilled in the art after reading the detailed description, without going beyond the scope of the invention.

### BRIEF DESCRIPTION OF THE DRAWINGS

FIG. 1 shows a mixing device for plastic products according to the prior art.

FIG. 2 shows a section of the rotor, parallel to the blades' axle, according to an embodiment of this invention.

FIG. 3 shows a section of the rotor, perpendicular to the blades' axle, according to an embodiment of this invention.

FIG. 4 shows a vertical section of a blade and its holder according to an embodiment of this invention.

FIG. 5 shows a transversal section of a blade holder lodged in the rotor according to an embodiment of this invention.

FIG. 6 is a sketch of the mixing procedure according to the prior art.

FIG. 7 is a sketch of the mixing procedure according to an embodiment of this invention.

FIG. 8 is a sketch representing a device according to a second embodiment of this invention.

FIG. 9 is a sketch representing a device according to a third embodiment of this invention.

FIG. 10 is a sketch representing a device according to a fourth embodiment of this invention.

FIG. 11 is a sketch representing a device according to a fifth embodiment of this invention.

### DETAILED DESCRIPTION OF THE INVENTION

### Embodiment 1

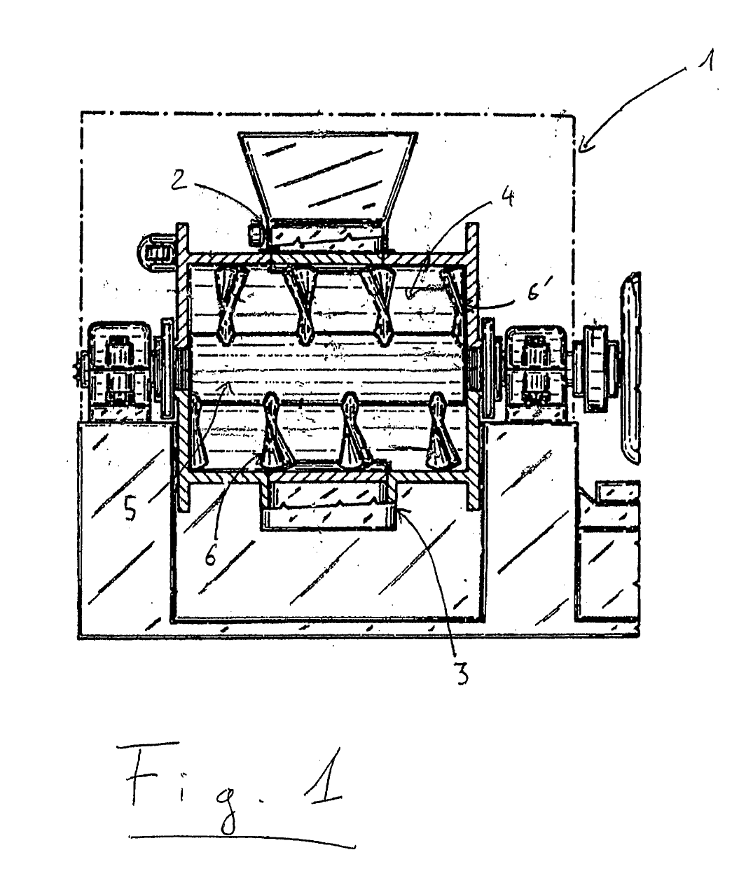

FIG. 1 shows a treatment device according to the prior art, comprising a mixing device for plastic products 1, comprising among others an inlet 2, an outlet 3, a mixing chamber 4, and a rotor 5, on which are fixed blades 6 alternately on one side or the other at 180°. Such device operates in a discontinued manner, as explained below.

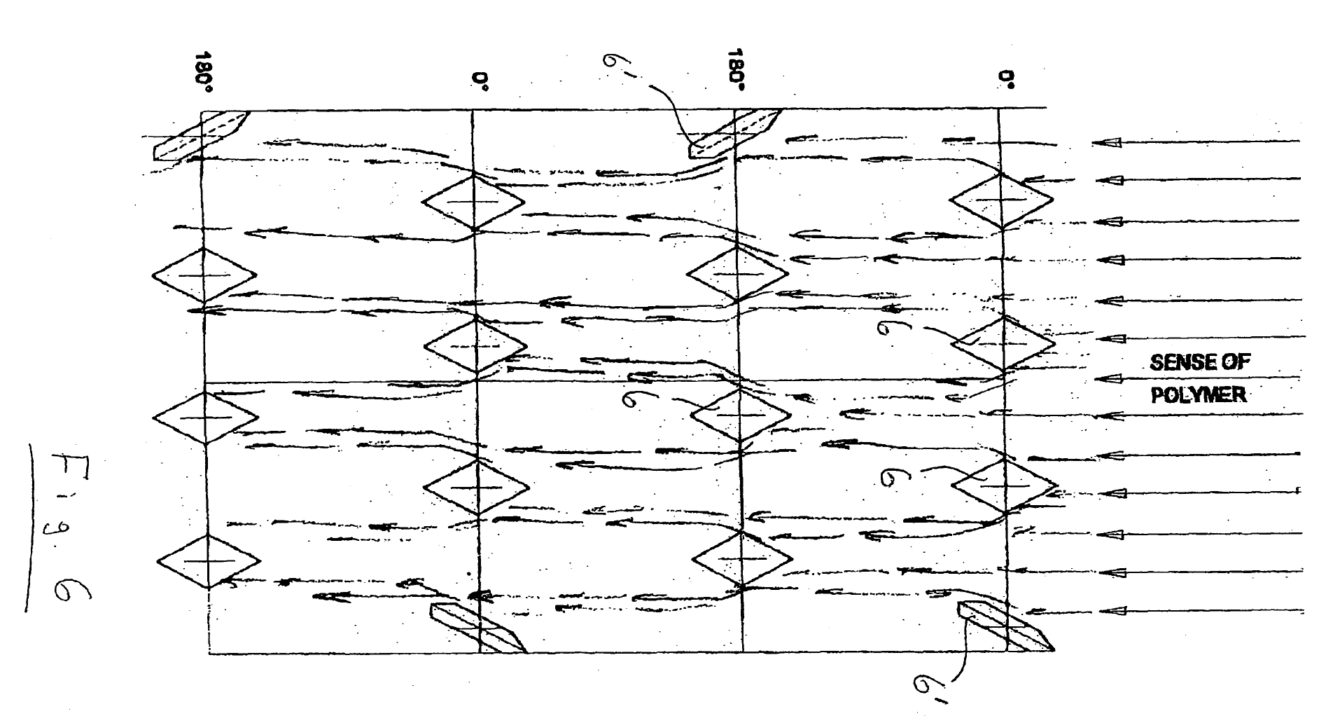

An amount of product is introduced into the mixing chamber 4 via inlet 2; the chamber is then hermetically closed and the rotor 5 begins to revolve at high speed, thus transmitting mechanical energy to the products that are to be mixed. After a while, depending on the mixing conditions, such as the rotation speed of the rotor 5, the type of products, the deceleration prior to opening doors 2 and 3, and any such similar, the products are transformed into a more or less homogeneous paste and are then evacuated through outlet 3. The mixing process for the products using this type of device of the prior art is illustrated in FIG. 6, where each blade can be seen cutting the flow of those products arriving into two equal parts, with the next blade cutting each part again into two equal parts, without really mixing the parts cut.

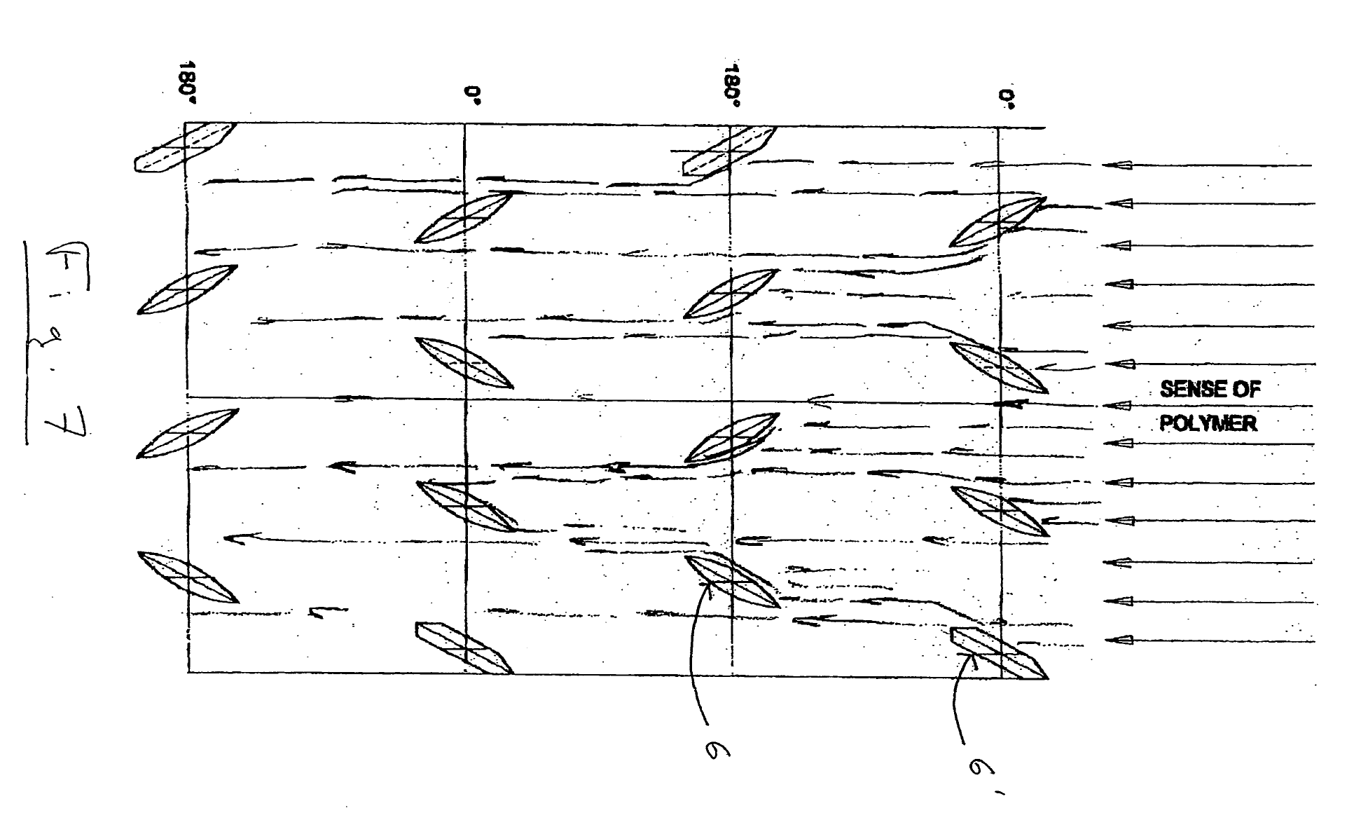

This invention uses such type of device, and allows for the oval non-cutting blades 6 to be positioned in order to rotate around the axles perpendicular to the rotor's axle. In the continual stirring process of the mixed waste, the rotating blades 6 continuously cut the said mixture of plastic products and diffuse the various portions of cut products one towards another in a methodical manner; more precisely, the first row of blades separates the product flow into a number of parts equal to the number of intervals between the blades 6, then the non-separated flow zones encounter a second row of blades separating them, and so forth, in order to enable a subtle mixture and thus to improve the mixing process as shown in FIG. 7.

When the mixture is homogenised, it is evacuated from the mixing chamber 4 via outlet 3 and is sent via a conveying screw 8 to a filter, before being degassed to remove all gasses imprisoned in the mass which alter the properties of the product. The product is then dispatched via another conveying screw towards an extrusion process in the shape of filaments, then by a pelleting process in view of subsequent use.

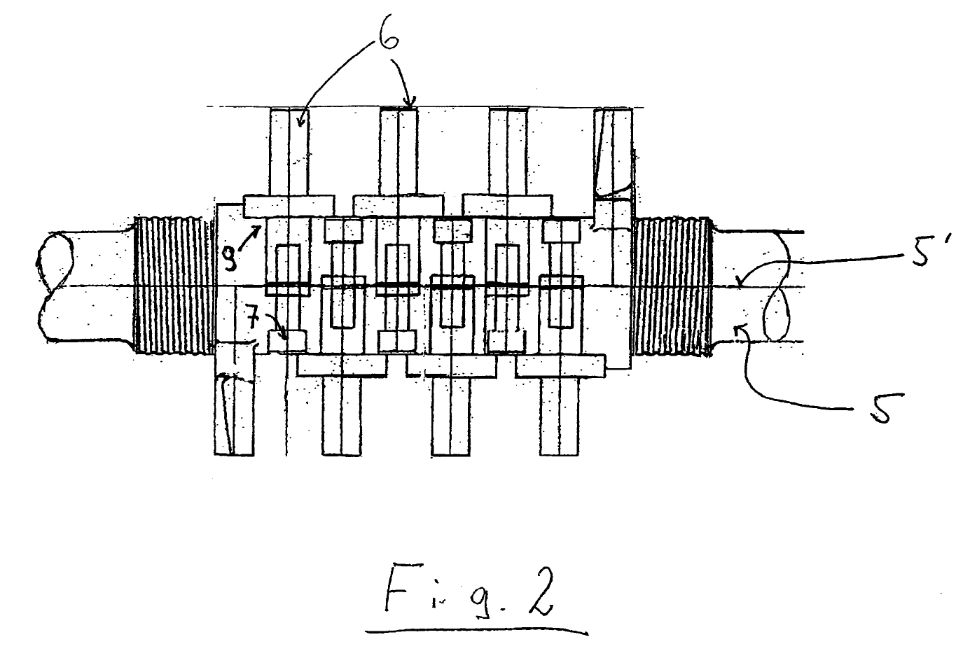

In FIG. 2, the blades 6 can be seen placed on a rotor 5 via their respective holders 9 put into mesh with the screws 7 opposite. These blades 6 are placed alternately from one side to another at 180° in order to provide a rotor equipped with alternating blades in the opposite direction. The rotor can revolve around its centre of symmetry 5′ at a speed running from 5,000 to 6,000 rpm in order to mix and combine the various products located in the device's closed chamber.

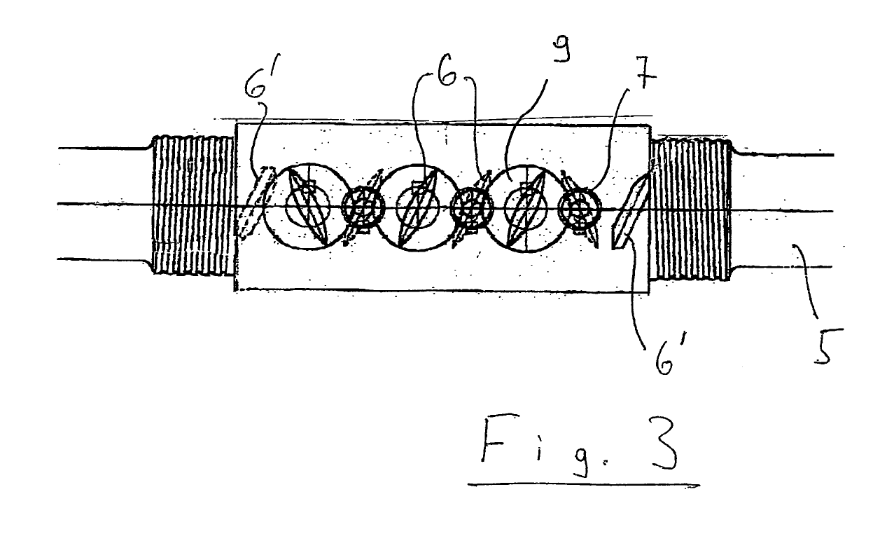

FIG. 3 shows a possible orientation of the blades 6, chosen with the aim of enhancing the device's efficiency. Indeed, by orientating the cutting edge of the blades 6 in such a manner, a whirlpool effect is created, thus enabling a greater division and crossing of the flows. It should be noted that the external blades 6′, i.e. the two blades at the tips of the rotor, are orientated so as to bring the product back towards the centre of the mixing chamber 4 so as not to have a dead zone inside the mixing chamber 4.

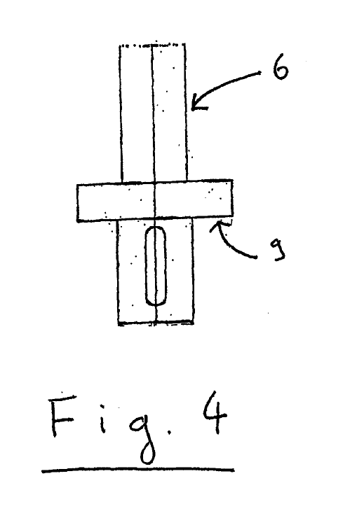

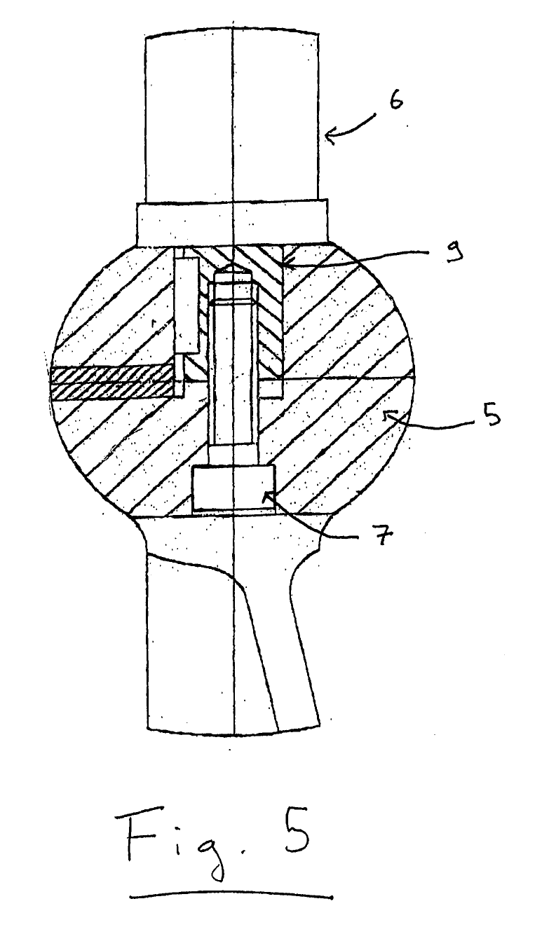

FIGS. 4 and 5, show a holder 9 for the rotating blades 6, which is fixed onto the rotor by putting into mesh with a screw 7, thus enabling an arbitrary orientation of the blades on an angle range from 0 to 180°, or a positioning in any one of the predetermined directions.

### Embodiment 2

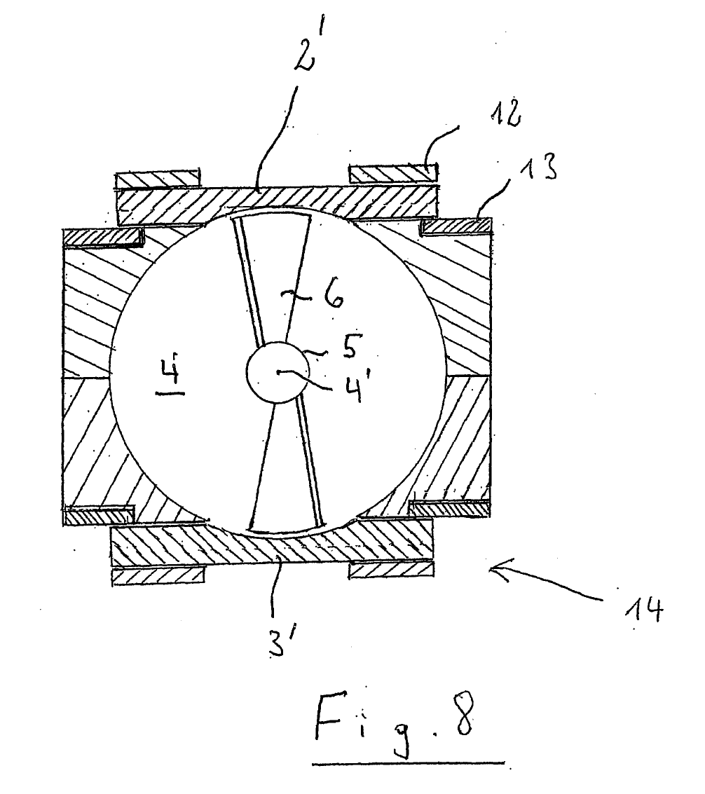

In FIG. 8 can be seen a mixing device for polymer corresponding to an embodiment 1 in which the inlet 2 and outlet 3 doors have been substituted by sliding doors 2′ and 3′ respectively, in order to achieve an enhanced sealing of the mixing chamber; such doors which, although not illustrated in detail in FIG. 1, are, in the prior art, made typically as swiveling doors.

Indeed, using the sliding doors 2′ and 3′ prevents deposit of the product on the contact surfaces between the door and wall of the mixing chamber 4, thus enabling improved sealing in the long term.

The upper sliding door consists of a plate 2′ which slides between the rails 12 and 13 and comprises, on its surface facing the inside, a concave surface having the same bending radius as the mixing chamber 4.

The lower door comprises a plate 3′ which slides between the rails 14 and which comprises on its surface facing the inside, a concave surface similar to that of the plate 2′.

### Embodiment 3

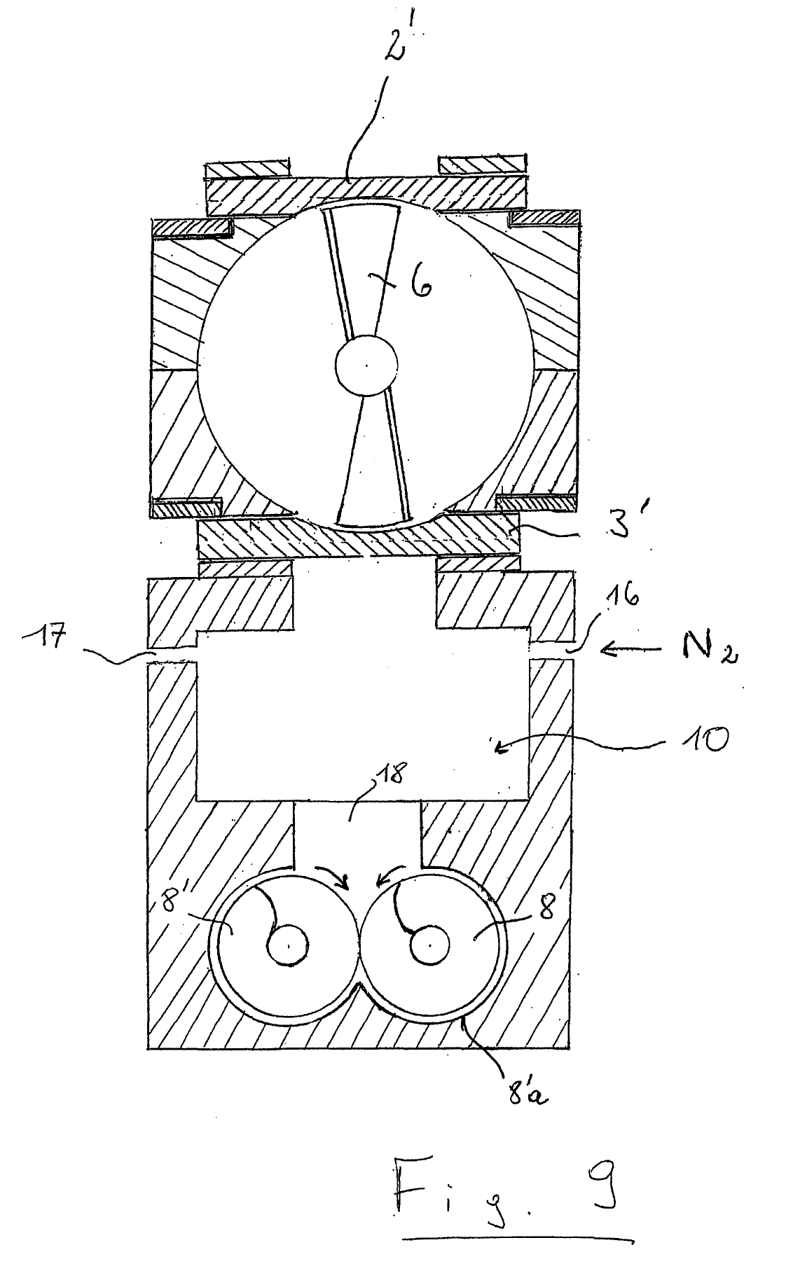

In FIG. 9, can be seen a mixing device for polymer, such as represented by embodiment 2, in which the product evacuated from the mixing chamber 4 is handled by a double conveying screw 8 and 8′, both turning anti-clockwise in a recess 8′a, after outlet 3, to enable a better grasp of the combined product. Next, the product is subjected to a partial degassing process.

In FIG. 9, a ventilation chamber 10 is also shown according to embodiment 4, noting that the presence of such chamber is optional.

### Embodiment 4

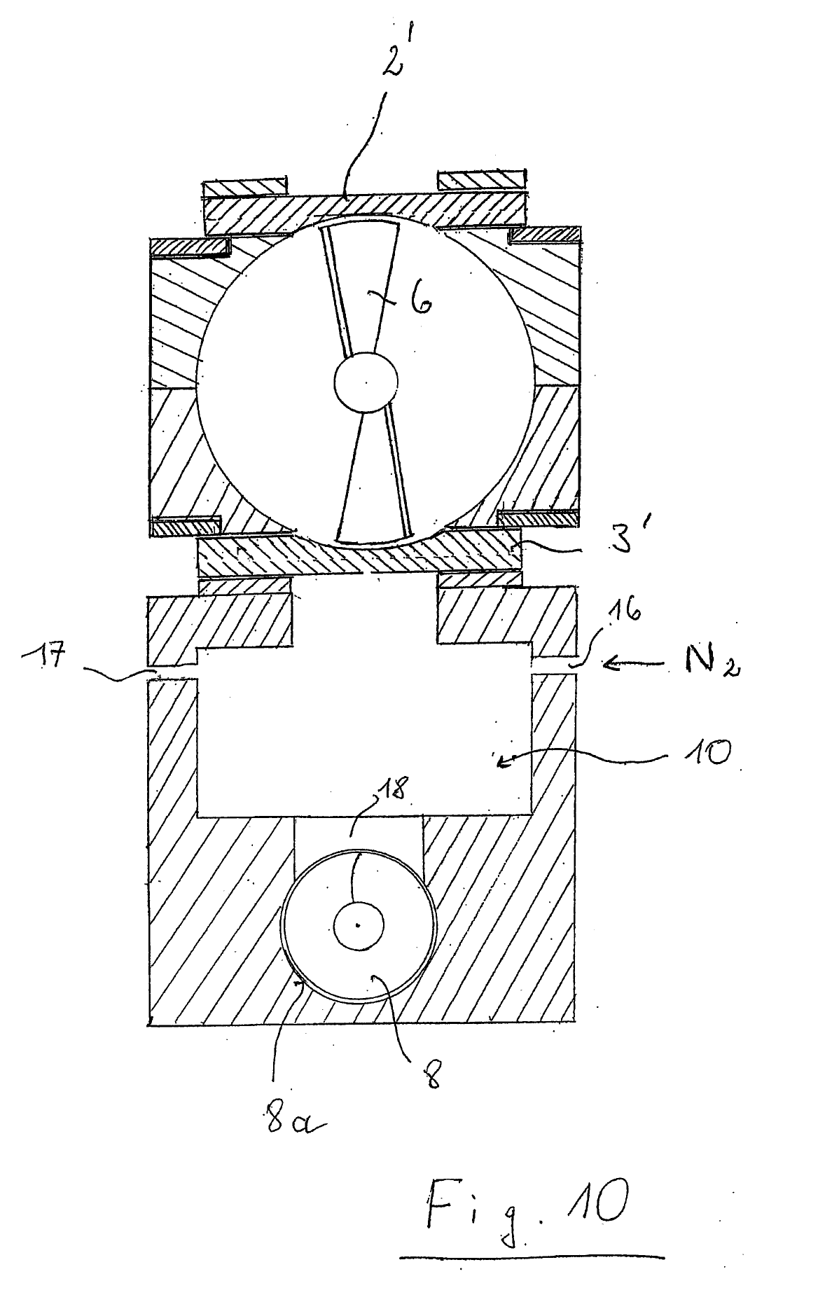

In FIG. 10 can be seen a mixing device for polymer such as shown in FIG. 8. In this figure can be seen an inert gas chamber 10 between the outlet 3 and the screw 8, which enables a better conservation of the product.

Indeed, this inert gas chamber enables to avoid contact between the product and an oxidizer such as air, for example. The inert gas may be nitrogen, argon or any other conventional inert gas.

The upper part of the device of this fourth embodiment of the invention corresponds to the device in FIG. 8.

A transfer chamber 10, which is ventilated with an inert gas such as N₂, can be distinguished below the outlet door 3′, and lower still can be seen a conveying screw 8, which is lodged in a rotating manner in a bore 8a.

The chamber 10 comprises two openings 16 and 17, one of which is used to conduct the inert gas and the other to evacuate the gas surplus.

Beneath the chamber 10, a recess 18 serves as a transfer duct between the chamber 10 and the bore 8a.

The product treated is evacuated via the conveying screw in a direction perpendicular to the drawing plan, in order to attain an extrusion station.

### Embodiment 5

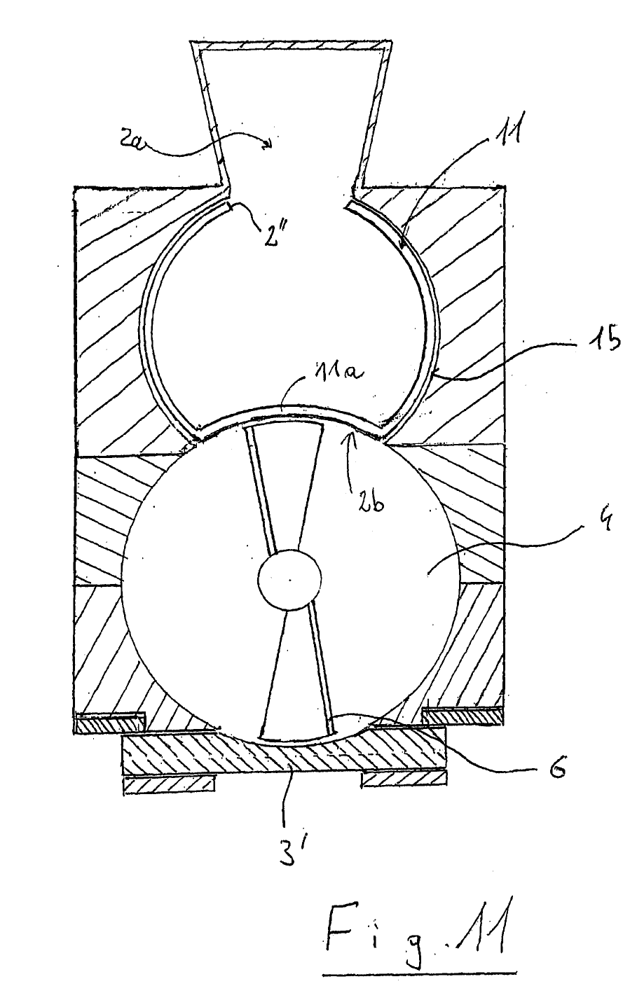

In FIG. 11 can be seen a mixing device for polymer, such as represented in FIG. 8. This device further comprises a cylinder 11 inserted into a second chamber 15 placed just above the mixing chamber 4 and comprising an opening 2b shared with the mixing chamber. This cylinder is equipped with an inlet opening 2″ for the product to be mixed and is capable of revolving around a rotating axle parallel to that of the rotor, thus enabling its opening to face alternately inlet 2a for introducing the products, and opening 2b for pouring out the products introduced previously.

In such a manner, the amount of the different products to be introduced into the mixing chamber can be calculated in advance.

On a part of the circumference of cylinder 11 is a part 11a, the bend of which can be distinguished from the rest of cylinder 11 in order to follow the bend of the mixing chamber 4.

In this manner, during the rotor's stirring phase, the outline of the mixing chamber is exactly circular, whereas in the loading phase, the cylinder is overturned by 180° and some parts of the cylinder enter chamber 4, which is possible on the condition that the blades 6 are placed in a more or less horizontal direction.

1. A mixing device for plastic products comprising:
a mixing chamber;
a product inlet and outlet;
a conveying screw for evacuations;
at least one rotor in the mixing chamber equipped with blades,
wherein the said blades are fixed onto the said rotor in a rotating manner around the axles perpendicular to the rotor axle.

2. A mixing device for plastic products according to claim 1, in which the said rotating blades shave preferably an oval profile and are in mesh with a screw on the said rotor and are aligned on either side in an alternate manner on the said rotors, extending in a radial direction in relation to the axle of the said rotor.

3. A mixing device for plastic products according to claim 2, in which the blades at the tips of the said rotor are fixed and bring the product back towards the inside of the mixing chamber.

4. A mixing device for plastic products according to claim 1, in which an inlet and an outlet each have a sliding door running between the rails and having a concave shape on the surface facing the inside having basically a same bending radius as the said mixing chamber.

5. A mixing device for plastic products according to claim 1, in which a chamber with inert gas, ventilated with an inert gas, is located just below the said outlet and above the said conveying screwy.

6. A mixing device for plastic products according to claim 5, wherein the said inert gas chamber comprises at least two openings for gas circulation.

7. A mixing device for plastic products according to claim 5, in which the said inert gas may be nitrogen, argon or any other inert gas.

8. A mixing device for plastic products according to claim 1, in which the product is evacuated via a double screw and turning anti-clockwise, located in a bore.

9. A mixing device for plastic products according to claim 1, wherein a second chamber, located above the said mixing chamber and sharing an opening with the said mixing chamber, comprises a means to pre-load the plastic products in pellets.

10. A mixing device for plastic products according to claim 9, in which the said second chamber includes a cylinder, comprising an opening as well as a concave part having the same bending radius as the said mixing chamber, the said cylinder being likely to rotate by at least 180°, the said cylinder being located above the said mixing chamber, in such a manner that during the rotation of the said cylinder its opening comes to face the said loading opening of the said mixing chamber.

11. A mixing procedure for plastic products using a device according to claim 1.

12. A procedure according to claim 11, comprising the following phases:
introducing the products in pellet form into the said mixing chamber via an inlet;
turning the said rotor to thus enable the mixing of the pellets until fusion of the said pellets via the heat due to friction between the said pellets;
evacuating the mixture via an outlet of the said mixing chamber in the direction of a means of evacuation;
subjecting the product to filtering, then to degassing and to an extrusion in filaments;
subjecting the product to a pelleting process.
